(19) United States
(12) Patent Application Publication
(10) Pub. No.: US 2026/0217987 A1
(43) Pub. Date: Jul. 30, 2026

(54) ROOFING MEMBRANE HAVING DECREASED WATER ABSORPTION

(71) Applicant: BMIC LLC, Dallas, TX (US)

(72) Inventors: Yan Zheng, Parsippany, NJ (US); Yixi Xiao, Parsippany, NJ (US); Joshua Tingley, Morris Plains, NJ (US)

(21) Appl. No.: 19/459,649

(22) Filed: Jan. 26, 2026

Related U.S. Application Data
(60) Provisional application No. 63/750,006, filed on Jan. 27, 2025.
(60) Provisional application No. 63/759,725, filed on Feb. 18, 2025.

(51) Int. Cl. C09D 5/16; C09D 7/40; C09D 7/61; C09D 7/63; C09D 7/65; C09D 171/00; E04D 5/10

(52) U.S. Cl. CPC C09D 5/1637; C09D 5/1625; C09D 7/61; C09D 7/63; C09D 7/65; C09D 7/67; C09D 7/68; C09D 7/69; C09D 171/00; E04D 5/10

(57) ABSTRACT

A roofing membrane includes a substrate and a cured polymer layer disposed on the substrate, where the cured polymer layer includes 0.01-40 wt. % hydrophobic additive, 15-60 wt. % silyl-terminated polymer, and 15-60 wt. % inorganic filler, where water absorption of the roofing membrane is less than 25% by weight after an exposure period of 7 days when tested according to ASTM D471. The hydrophobic additive may include one or more of a hydrophobic polyether, a hydrophobic silane, a fatty acid ester, an organic titanate compound, a siloxane polymer, and a silicone glycol copolymer.

### CROSS-REFERENCE TO RELATED APPLICATIONS

This application claims the benefit of priority under 35 U.S.C. § 119 (e) of U.S. Provisional Application No. 63/750,006, filed Jan. 27, 2025, and U.S. Provisional Application No. 63/759,725, filed Feb. 18, 2025, the contents of which are incorporated herein by reference in their entirety.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a schematic diagram of a cross-section of a roofing membrane according to some embodiments.

FIG. 2 shows the molecular structures of example polysiloxanes according to some embodiments.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within this disclosure.

### SUMMARY

In accordance with some embodiments, a roofing membrane includes a substrate and a cured polymer layer disposed on the substrate, where the cured polymer layer includes 0.01-40 wt. % hydrophobic additive, 15-60 wt. % silyl-terminated polymer, and 15-60 wt. % inorganic filler. In some embodiments, the cured polymer layer may include a catalyst. The hydrophobic additive includes one or more of a hydrophobic polyether, a hydrophobic silane, a fatty acid ester, an organic titanate compound, a siloxane polymer, and a silicone glycol copolymer. The cured polymer layer includes a sufficient amount of the hydrophobic additive such water absorption of the cured polymer layer is less than 25% by weight after an exposure period of 7 days when tested according to ASTM D471.

In some embodiments, the cured polymer layer includes 5-40 wt. % of the hydrophobic polyether. A hydrophobic polyether may be selected from polypropylene glycol, a polypropylene monoester, and a polypropylene diether. An example hydrophobic polyether includes polypropyleneglycol diglycidylether.

In some embodiments, the cured polymer layer includes 0.1-10 wt. % of the hydrophobic silane. A hydrophobic silane may include an alkylfunctional silane, such as hexadecyltrimethoxysilane.

In some embodiments, the cured polymer layer includes 0.5-40 wt. % of the fatty acid ester.

In some embodiments, the cured polymer layer includes 0.01-5 wt. % of the organic titanate compound. An organic titanate compound may include an organic titanium chelate mixed with a silane, for example.

In some embodiments, the cured polymer layer includes 0.5-30 wt. % of the siloxane polymer. An example siloxane polymer may include a polydimethylsiloxane or a polyphenylmethyl siloxane. Further example siloxane polymers include a diphenylsiloxane-dimethylsiloxane copolymer, a phenylmethylsiloxane-dimethylsiloxane copolymer, polyoctylmethylsiloxane, an ethylmethylsiloxane-2-phenylpropylmethylsiloxane copolymer, a poly(3,3,3-trifluoropropylmethylsiloxane), or a dimethylsiloxane-ethylene oxide block copolymer.

In some embodiments, the cured polymer layer includes 0.5-20 wt. % of the silicone glycol copolymer.

In some embodiments, the silyl-terminated polymer may have a viscosity of 30000 to 62000 cP at 25° C. The silyl-terminated polymer may include a silyl-terminated polyether, for example.

In some embodiments, the inorganic filler includes calcium carbonate particles. Calcium carbonate particles may have a median particle size of 1 micrometer to 25 micrometers or a median particle size of 0.05 micrometer to 1 micrometer.

In some embodiments, the cured polymer layer includes 0.01-3 wt. % of a catalyst. A catalyst may include an organo-tin compound, such as a monobutyl tin compound, a dibutyl tin compound, or a dioctyl tin compound, such as dimethyltin bis(neodecanoate).

In some embodiments, the cured polymer layer may include 0.01-45 wt. % plasticizer. In some embodiments, the cured polymer layer may include 1-5 wt. % pigment. A pigment may include particles of titanium oxide, for example. Pigment particles may have a median particle size of 0.1 micrometer to 2 micrometers.

In some embodiments, the cured polymer layer may include 0.1-3 wt. % adhesion promoter. An adhesion promoter may include a bifunctional organosilane compound, such as N-(2-aminoethyl)-3-aminopropyltrimethoxysilane.

In some embodiments, the cured polymer layer may include 0.01 to 3 wt. % moisture scavenger. A moisture scavenger may include an ethyl polysilicate, 1,1,1,3,3,3-hexamethyldisilazane, or an organofunctional silane.

According to some embodiments, a cured polymer layer includes 0.01-40 wt. % hydrophobic additive, where the hydrophobic additive includes one or more of a hydrophobic polyether, a hydrophobic silane, a fatty acid ester, an organic titanate compound, a siloxane polymer, and a silicone glycol copolymer, 20-45 wt. % silyl-terminated polymer, and 15-65 wt. % inorganic filler, where water absorption of the cured polymer layer is less than 25% by weight after an exposure period of 7 days when tested according to ASTM D471.

### DETAILED DESCRIPTION OF EXEMPLARY EMBODIMENTS

Embodiments of the present disclosure relate generally to polymer materials and more specifically to silyl-terminated polymers and layers or membranes formed therefrom. In some embodiments, polymer resin formulations are modified to increase their resistance to water uptake such that corresponding silyl-terminated polymer layers/membranes exhibit lower water absorption compared to layers/membranes formed from unmodified compositions.

The present disclosure relates also to a roofing membrane. In some embodiments, the roofing membrane includes a substrate and a cured polymer layer disposed on the substrate, where the cured polymer layer includes 0.01-40 wt. % of a hydrophobic additive, 15-60 wt. % of a silyl-terminated polymer, and 15-60 wt. % of an inorganic filler. The hydrophobic additive may include one or more of a hydrophobic polyether, a hydrophobic silane, a fatty acid ester, an organic titanate compound, a siloxane polymer, and a silicone glycol copolymer.

As used herein, the term “silyl-terminated polymer” refers to a class of polymers that contain silane groups (Si—H, Si—R) at the ends of their polymer chains. These silane groups can react with moisture to form siloxane (Si—O—Si) bonds, enabling cross linking and properties such as improved adhesion and mechanical flexibility.

In some embodiments, the disclosed resins may be moisture curable. A “moisture curable” resin utilizes moisture to drive a curing mechanism. To promote curing, the resin may be exposed to moisture by spraying with water, exposure to ambient humidity, or a combination thereof. In some embodiments, a cured polymer layer may be formed from a resin formulation.

As disclosed herein, silyl-terminated polymer (STP) resin formulations may be modified to include various additives that are configured to decrease the absorption of water by the resin. The additives may include one or a combination of hydrophobic compounds.

In some embodiments, a resin formulation includes 0.01-40 wt. % hydrophobic additive, 15-60 wt. % silyl-terminated polymer, and 15-60 wt. % inorganic filler. By way of example, a resin formulation may include 0.01 to 40 wt. % hydrophobic additive, e.g., 0.01, 0.02, 0.05, 0.1, 0.2, 0.5, 1, 2, 5, 10, 15, 20, 25, 30, 35, 40 or 45 wt. % hydrophobic additive, including ranges between any of the foregoing values, 20 to 45 wt. % silyl-terminated polymer, e.g., 20, 25, 30, 35, 40 or 45 wt. % silyl-terminated polymer, including ranges between any of the foregoing values, and 15-65 wt. % inorganic filler, e.g., 15, 20, 25, 30, 35, 40, 45, 50, 55, 60 or 65 wt. % inorganic filler, including ranges between any of the foregoing values. In some embodiments, the resin formulation may include a polymerization catalyst.

In some embodiments, the resin formulation may include one or more hydrophobic additives that decrease the material's tendency to absorb water. The hydrophobic additive(s) may decrease the surface energy of the resin making it less prone to interact with water molecules. In some embodiments, the hydrophobic additive(s) may form a barrier that prevents water from penetrating the material, thus inhibiting water absorption. Water absorption of a cured polymer layer formed using a disclosed resin formulation may be less than 25% by weight of the layer.

In accordance with some embodiments, the hydrophobic additive may include one or more of (A) a hydrophobic polyether, (B) a hydrophobic silane, (C) a fatty acid ester, (D) an organic titanate compound, (E) a siloxane polymer, and (F) a silicone glycol copolymer.

### A. Hydrophobic Polyether

In some embodiments, a hydrophobic polyether may constitute 5-40 wt. % of a resin formulation, e.g., 5, 10, 15, 20, 25, 30, 35, or 40 wt. %, including ranges between any of the foregoing values. Example hydrophobic polyethers include silicone polyethers, polypropylene glycol, polypropylene monoesters, and polypropylene diethers, such as polypropyleneglycol diglycidylether. In some embodiments, a hydrophobic polyether compound may function as a plasticizer.

### B. Hydrophobic Silane

In some embodiments, a resin formulation may include 0.1-10 wt. % of a hydrophobic silane. For example, a hydrophobic silane may constitute 0.1, 0.2, 0.5, 1, 2, 5, 7, or 10 wt. % of a resin formulation, including ranges between any of the foregoing values. Hydrophobic silanes may include a silane compound having a hydrophobic side chain, such as an alkyl, fluorinated alkyl, or alkene moiety. Illustrative hydrophobic silanes include alkylfunctional silanes, such as hexadecyltrimethoxysilane.

### C. Fatty Acid Ester

In some examples, a resin formulation may include 0.5-40 wt. % of a fatty acid ester. In some embodiments, a resin formulation may include 0.5, 1, 2, 5, 10, 15, 20, 25, 30, 35, or 40 wt. % of a fatty acid ester, including ranges between any of the foregoing values. Suitable fatty acid esters may include soybean oil, coconut oil, linseed oil, castor oil, and esters of coco fatty acid and poly glycerin. Fatty acid esters may include an ether such as glycerol 1,2-propane glycol ether. In some embodiments, a fatty acid ester may additionally perform as a plasticizer.

### D. Organic Titanate Compound

In some examples, a resin formulation may include 0.01-5 wt. % of an organic titanate compound, e.g., 0.01, 0.02, 0.05, 0.1, 0.2, 0.5, 1, 2, 3, 4, or 5 wt. %, including ranges between any of the foregoing values. By way of example, an organic titanate compound may include an organic titanium chelate mixed with a silane compound. For instance, an organic titanate compound may include a titanium ethyl acetoacetate complex and methyl trimethoxy silane, i.e., a diisopropoxy-bisethylacetoacetatotitanate. Such an additive may additionally operate as a cross-linking agent, curing agent and/or adhesion promoter.

### E. Siloxane Polymer

In some embodiments, a resin formulation may include 0.5-30 wt. % of a siloxane polymer. For instance, a resin formulation may include 0.5, 1, 2, 5, 10, 15, 20, 25, or 30 wt. % of a siloxane polymer, including ranges between any of the foregoing values. Exemplary siloxane polymers include polydimethylsiloxane (PDMS), trimethylsilyl terminated PDMS, and polyphenylmethyl siloxanes, such as diphenylsiloxane-dimethylsiloxane copolymer, phenylmethylsiloxane-dimethylsiloxane copolymer, polyoctylmethylsiloxane, ethylmethylsiloxane-2-phenylpropylmethylsiloxane copolymer, poly(3,3,3-trifluoropropylmethylsiloxane), dimethylsiloxane-ethylene oxide block copolymer, as well as combinations thereof.

### F. Silicone Glycol Copolymer

In some embodiments, a resin formulation may include 0.5-20 wt. % of a silicone glycol copolymer, e.g., 0.5, 1, 2, 3, 5, 10, 15, or 20 wt. %, including ranges between any of the foregoing values. Example silicone glycol copolymers include dimethicone-polyethylene glycol copolymer, cetearyl-methicone copolymer, polysilicone-polyethylene glycol copolymer, although further compositions are contemplated.

In some embodiments, the resin formulation includes a sufficient amount of the hydrophobic additive such that, when the resin formulation is formed into a cured polymer layer, water absorption of the polymer layer is less than 25% by weight of the polymer layer after an exposure period of 7 days when tested according to ASTM D471. By way of example, relative to an initial weight of a polymer layer or membrane, the water absorption may be 0.1, 0.2, 0.5, 1, 2, 5, 10, 15, 20, or 25 wt. %, including ranges between any of the foregoing values.

The silyl-terminated polymer (STP) may include a silyl-terminated polyether, for example. Further example silyl-terminated polymers include silyl-terminated polyurethanes, silyl-terminated polyether urethanes, and silyl-terminated acrylic polymers. A silyl-terminated polymer may be moisture curable. Representative silyl-terminated polymers may be characterized by a room temperature viscosity of 30000 to 62000 cP. In some embodiments, the room temperature viscosity of the silyl-terminated polymer may be 30000, 35000, 40000, 45000, 50000, 55000, 60000, or 62000 cP, including ranges between any of the foregoing values.

In some embodiments, the resin formulation may include an inorganic filler. In certain examples, an inorganic filler may include particles of calcium carbonate (CaCO₃) having a median particle size of 1 to 25 micrometers, e.g., 1, 2, 5, 10, 15, 20, or 25 micrometers, including ranges between any of the foregoing values. In certain examples, an inorganic filler may include calcium carbonate particles having a median particle size of 0.05 to 1 micrometer, e.g., 0.05, 0.1, 0.2, 0.5, or 1 micrometer, including ranges between any of the foregoing values.

An example filler material includes nano-sized, precipitated calcium carbonate particles having a median particle size of approximately 0.07 micrometers with a surface area of approximately 20 m²/g. A further example filler material includes surface treated, ground calcium carbonate particles having a median particle size of approximately 3.2 micrometers, such as granular calcium carbonates. In some embodiments, a resin formulation may include two or more filler materials.

In some embodiments, the resin formulation may include a catalyst. A catalyst may be included in an amount effective to induce curing of the resin. Example resin formulations include 0.01-3 wt. % catalyst, e.g., 0.01, 0.02, 0.05, 0.1, 0.2, 0.5, 1, 2, or 3 wt. %, including ranges between any of the foregoing values. In some embodiments, the catalyst may include an organo-tin compound, such as a monobutyl tin compound, a dibutyl tin compound, or a dioctyl tin compound, such as dimethyltin bis(neodecanoate), although the catalyst composition is not particularly restricted.

In some embodiments, additional additives may include plasticizers and pigments. For example, a resin formulation may include 0.01-45 wt. % plasticizer, e.g., 0.01, 0.02, 0.05, 0.1, 0.2, 0.5, 1, 2, 5, 10, 15, 20, 25, 30, 35, 40 or 45 wt. %, including ranges between any of the foregoing values. Example plasticizers include methoxypolyethylene glycol, such as methoxypolyethylene glycol, triethylene glycol bis(2-ethylhexanoate), and propylene glycol-initiated polyether polyol. In some embodiments, a resin formulation may include two or more plasticizer materials.

In some embodiments, a resin formulation may include 1-5 wt. % pigment, e.g., 1, 2, 3, 4, or 5 wt. %, including ranges between any of the foregoing values. A pigment may include particles of an inorganic nitride or oxide, such as titanium dioxide. Particles of a pigment may have a median particle size of 0.1 to 2 micrometers, e.g., 0.1, 0.2, 0.5, 1, or 2 micrometers, including ranges between any of the foregoing values. An example titanium oxide (TiO₂) pigment includes rutile titanium dioxide.

In some embodiments, the resin formulation may include 0.1-3 wt. % of an adhesion promoter. An adhesion promoter may include a vinyl functional silane such as vinyltrimethoxysilane, or a bifunctional organosilane compound, such as N-(2-aminoethyl)-3-aminopropyltrimethoxysilane.

In some embodiments, the resin formulation may additionally include 0.01 to 3 wt. % of a moisture scavenger. For example, a resin formulation may include 0.01, 0.02, 0.05, 0.1, 0.2, 0.5, 1, 2, or 3 wt. % moisture scavenger, including ranges between any of the foregoing values. Suitable moisture scavengers include, but are not limited to, an ethyl polysilicate, 1,1,1,3,3,3-hexamethyldisilazane (HMDS), or an organofunctional silane.

In some embodiments, a resin formulation may include a coupling agent. A coupling agent may be adapted to improve adhesion between the polymer and the filler and improve one or more mechanical properties of a cured polymer layer formed from the resin formulation, such as strength, stiffness, and impact resistance. A coupling agent may help distribute the fillers more uniformly throughout the polymer matrix, leading to more consistent material properties. In some embodiments, a resin formulation may include a UV absorber and/or light stabilizer. Example UV absorbers/light stabilizers include hindered amine light stabilizers (HALS) and benzotriazole derivatives, such as 1,2-benzotriazole, 2-(2-hydroxy-3,5-di-tert-butylphenyl)-2H-benzotriazole, and 2-(2-hydroxy-3,5-di-tert-butylphenyl)-5-chlorobenzotriazole. In some embodiments, a resin formulation may include a rheology modifier, such as a micronized amide wax. A rheology modifier may be designed to improve sheer thinning performance and extrusion properties for the high temperature manufacture of moisture curing polymers.

In some embodiments, a cured polymer layer includes 0.01-40 wt. % hydrophobic additive, 15-60 wt. % silyl-terminated polymer, and 15-60 wt. % inorganic filler, where the hydrophobic additive includes one or more of a hydrophobic polyether, a hydrophobic silane, a fatty acid ester, an organic titanate compound, a siloxane polymer, and a silicone glycol copolymer. The water absorption of the cured polymer layer may be less than 25% by weight of the layer after an exposure period of 7 days when tested according to ASTM D471.

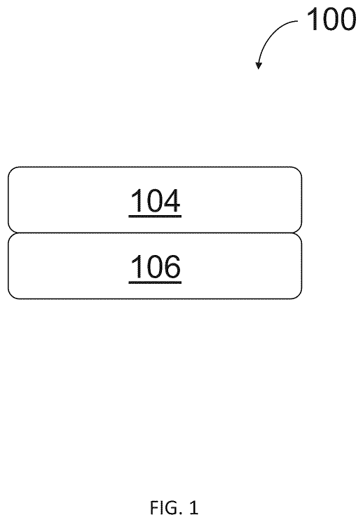

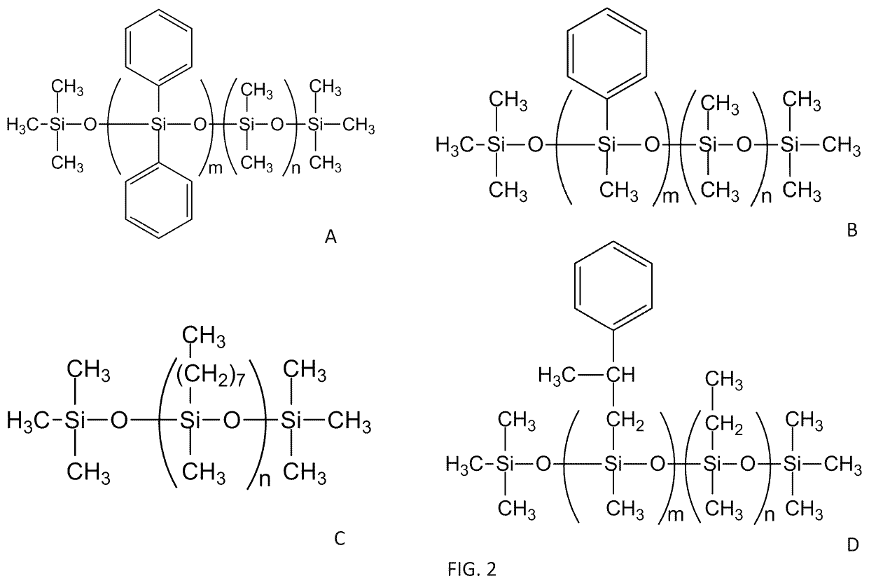

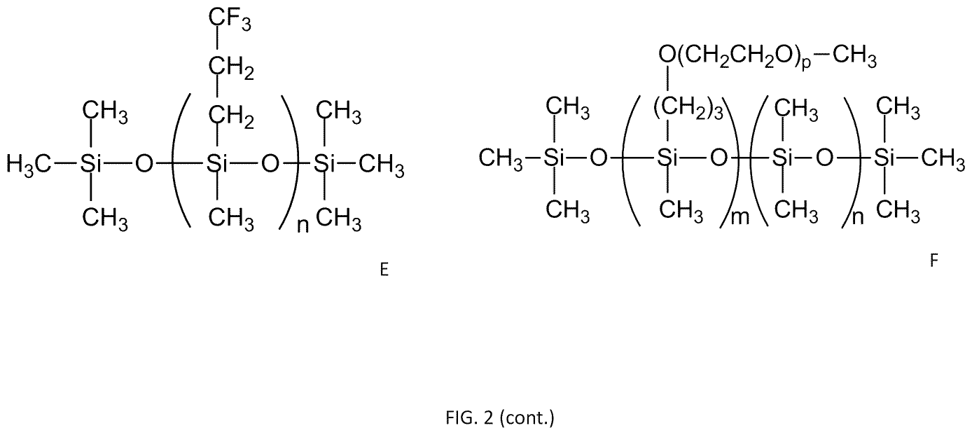

The following will provide, with reference to FIGS. 1 and 2, detailed descriptions of resin formulations used to form cured polymer layers having decreased water absorption properties. The discussion associated with FIG. 1 includes a description of a roofing membrane including a cured polymer layer as disclosed herein. The discussion associated with FIG. 2 includes a description of example polysiloxane additives for forming low water absorbance STP layers and membranes.

Referring to FIG. 1, shown is a schematic diagram of a cross-section of a roofing membrane 100, according to some embodiments. As shown in FIG. 1, in some embodiments, the roofing membrane comprises a cured polymer layer 104 overlying a substrate 106. In some embodiments, cured polymer layer 104 directly overlies substrate 106.

Referring to FIG. 2, example polysiloxane additives used to form a cured polymer layer include diphenylsiloxane-dimethylsiloxane copolymer (FIG. 2A), phenylmethylsiloxane-dimethylsiloxane copolymer (FIG. 2B), polyoctylmethylsiloxane (FIG. 2C), ethylmethylsiloxane-2-phenylpropylmethylsiloxane copolymer (FIG. 2D), poly(3,3,3-trifluoropropylmethylsiloxane) (FIG. 2E), and dimethylsiloxane-ethylene oxide block copolymer (FIG. 2F), although further polysiloxanes, as well as combinations thereof, are contemplated.

### Examples

Summarized in Tables 1-4 are Comparative and Example resin formulations including selected hydrophobic additives illustrating some embodiments of the present invention. Tables 1-4 also include performance data showing 7 day water absorption values for each composition. Relative to the Comparative Examples, the incorporation of a hydrophobic additive into a resin formulation may decrease water absorption by 40 to 80%, e.g., 40, 45, 50, 55, 60, 65, 70, 75 or 80%, including ranges between any of the foregoing values.

Referring to Table 1, a hydrophobic additive may include a hydrophobic polyether compound. The incorporation of 20 wt. % polypropylene diether into the resin formulation of Example 1 decreases the 7 day water absorption to approximately 22% from approximately 120% relative to Comparative Example 1.

TABLE 1
STP Formulation Including a Hydrophobic Polyether

| | Comparative | Example 1 |
|---|---|---|
| Component | Example 1 [wt. %] | [wt. %] |
| Hydrophobic Polyether | — | 20 |
| STP | 26.6 | 26.6 |
| Filler | 48 | 48 |
| Catalyst | 0.1 | 0.1 |
| Plasticizer | 20 | — |
| Pigment | 2 | 2 |
| Adhesion Promoter | 0.7 | 0.7 |
| Adhesion Promoter/ | 2.3 | 2.3 |
| Moisture Scavenger | | |
| UV Absorber | 0.2 | 0.2 |
| Rheology Modifier | 0.1 | 0.1 |
| 7 Day Water Absorption | 118% | 22% |

Referring to Table 2, a hydrophobic additive may include a hydrophobic silane compound. The incorporation of 1.5 wt. % hexadecyltrimethoxysilane-based rheology modifier into the resin formulation of Example 2 decreases the 7 day water absorption to approximately 23% from approximately 40-55% relative to Comparative Examples 2A and 2B.

TABLE 2
STP Formulation Including a Hydrophobic Silane

| | Comparative | Comparative | Example 2 |
|---|---|---|---|
| Component | Example 2A [wt. %] | Example 2B [wt. %] | [wt. %] |
| Hydrophobic Silane | — | — | 1.5 |
| STP | 33 | 33 | 33 |
| Filler | 45 | 45 | 45 |
| Catalyst | 0.2 | 0.2 | 0.1 |
| Plasticizer | 17 | 17 | 17 |
| Pigment | 2 | 2 | 2 |
| Adhesion Promoter | 1.3 | 2.8 | 1.4 |
| Adhesion Promoter/ | 1.5 | — | — |
| Moisture Scavenger | | | |
| 7 Day Water Absorption | 41% | 55% | 23% |

Turning to Table 3, a hydrophobic additive may include a fatty acid ester. As shown with reference to Example 3, the incorporation of 16 wt. % of a fatty acid ester into a resin formulation decreases the 7 day water absorption to approximately 12% from approximately 30% relative to Comparative Example 3.

TABLE 3
STP Formulation Including a Fatty Acid Ester

| | Comparative | Example 3 |
|---|---|---|
| Component | Example 3 [wt. %] | [wt. %] |
| Fatty Acid Ester | — | 16 |
| Hydrophobic Silane | 1.5 | 1.5 |
| STP | 33 | 34 |
| Filler | 45 | 45 |
| Catalyst | 0.2 | 0.2 |
| Plasticizer | 17 | — |
| Pigment | 2 | 2 |
| Adhesion Promoter | 1.3 | 1.3 |
| 7 Day Water Absorption | 29% | 12% |

Referring to Table 4, a hydrophobic additive may include an organic titanate compound. As shown with reference to Example 4, the incorporation into a resin formulation of 1 wt. % of a chemical composition including a titanium ethyl acetoacetate complex mixed with a methyl trimethoxy silane decreases the 7 day water absorption to approximately 9% from approximately 21% relative to Comparative Example 4.

TABLE 4
STP Formulation Including an Organic Titanate Compound

| | Comparative | Example 4 |
|---|---|---|
| Component | Example 4 [wt. %] | [wt. %] |
| Organic Titanate | — | 1 |
| STP | 35 | 33 |
| Filler | 45 | 45 |
| Catalyst | 0.2 | 0.2 |
| Plasticizer | 15 | 15 |
| Pigment | 2 | 2 |
| Adhesion Promoter | 1.3 | 1.3 |
| Adhesion Promoter/ | 1.5 | 2.5 |
| Moisture Scavenger | | |
| 7 Day Water | 21% | 9% |
| Absorption | | |

Further example resin formulations and corresponding 7-day water absorption data are summarized in Table 5. In Table 5, tor the various hydrophobic additives, the following abbreviations are used: hydrophobic polyether (HPPE), hydrophobic silane (HPS), fatty acid ester (FAE), and organic titanate compound (OTC). All components are listed in weight percent of the total composition.

TABLE 5
STP Formulations Including at Least One Hydrophobic Additive

| Component | Ex. 5 | Ex. 6 | Ex. 7 | Ex. 8 | Ex. 9 | Ex. 10 | Ex. 11 | Ex. 12 | Ex. 13 | Ex. 14 |
|---|---|---|---|---|---|---|---|---|---|---|
| HPPE | 20 | 15 | | 15 | 15 | | | | | |
| HPS | | | 2 | 1.5 | 2.5 | | | 2.5 | 2.5 | |
| FAE | | | 15 | | | 14 | 14 | | | |
| OTC | | | 1 | | | | | 1 | 1 | 1 |
| STP | 30 | 30 | 32.5 | 30 | 30 | 35 | 35 | 33 | 33 | 34 |
| Filler | 45 | 45 | 45 | 45 | 45 | 45 | 45 | 45 | 45 | 45 |
| Catalyst | 0.2 | 0.2 | 0.2 | 0.2 | 0.2 | 0.2 | 0.2 | 0.2 | 0.2 | 0.2 |
| Plasticizer | | | | | | | | 15 | 15 | 14 |
| Pigment | 2 | 2 | 2 | 2 | 2 | 2 | 2 | 2 | 2 | 2 |
| Adhesion | 1.3 | 1.3 | 2.3 | 1.3 | 1.3 | 1.3 | 1.3 | 1.3 | 1.3 | 1.3 |
| Promoter | | | | | | | | | | |
| Moisture | 1.5 | 1.5 | | 0.2 | | 1.5 | 1.5 | | | 2.5 |
| Scavenger | | | | | | | | | | |
| Coupling | | 5 | | 4.8 | 4 | | | | | |
| Agent | | | | | | | | | | |
| 7-Day Water | 16% | 11% | 16% | 11% | 8% | 10% | 11% | 6% | 10% | 16% |
| Absorption | | | | | | | | | | |

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

It will be understood that when an element such as a layer or a region is referred to as being formed on, deposited on, or disposed “on” or “over” another element, it may be located directly on at least a portion of the other element, or one or more intervening elements may also be present. In contrast, when an element is referred to as being “directly on” or “directly over” another element, it may be located on at least a portion of the other element, with no intervening elements present.

While various features, elements or steps of particular embodiments may be disclosed using the transitional phrase “comprising,” it is to be understood that alternative embodiments, including those that may be described using the transitional phrases “consisting of” or “consisting essentially of,” are implied. Thus, for example, implied alternative embodiments to a filler that comprises or includes calcium carbonate include embodiments where a filer consists essentially of calcium carbonate and embodiments where a filler consists of calcium carbonate.

What is claimed is:

1. A roofing membrane comprising:
a substrate; and
a cured polymer layer disposed on the substrate, wherein the cured polymer layer comprises:
0.01-40 wt. % hydrophobic additive,
wherein the hydrophobic additive comprises one or more compounds selected from the group consisting of a hydrophobic polyether, a hydrophobic silane, a fatty acid ester, an organic titanate compound, a siloxane polymer, and a silicone glycol copolymer;
15-60 wt. % silyl-terminated polymer; and
15-60 wt. % inorganic filler.

2. The roofing membrane of claim 1, wherein the cured polymer layer comprises a sufficient amount of the hydrophobic additive such water absorption of the cured polymer layer is less than 25% by weight after an exposure period of 7 days when tested according to ASTM D471.

3. The roofing membrane of claim 1, wherein the cured polymer layer comprises 5-40 wt. % of the hydrophobic polyether.

4. The roofing membrane of claim 1, wherein the hydrophobic polyether is selected from the group consisting of polypropylene glycol, a polypropylene monoester, and a polypropylene diether.

5. The roofing membrane of claim 1, wherein the hydrophobic polyether comprises polypropyleneglycol diglycidylether.

6. The roofing membrane of claim 1, wherein the cured polymer layer comprises 0.1-10 wt. % of the hydrophobic silane.

7. The roofing membrane of claim 1, wherein the hydrophobic silane comprises an alkylfunctional silane.

8. The roofing membrane of claim 1, wherein the hydrophobic silane comprises hexadecyltrimethoxysilane.

9. The roofing membrane of claim 1, wherein the cured polymer layer comprises 0.5-40 wt. % of the fatty acid ester.

10. The roofing membrane of claim 1, wherein the cured polymer layer comprises 0.01-5 wt. % of the organic titanate compound.

11. The roofing membrane of claim 1, wherein the organic titanate compound comprises an organic titanium chelate mixed with a silane.

12. The roofing membrane of claim 1, wherein the cured polymer layer comprises 0.5-30 wt. % of the siloxane polymer.

13. The roofing membrane of claim 1, wherein the siloxane polymer comprises a polydimethylsiloxane or a polyphenylmethyl siloxane.

14. The roofing membrane of claim 1, wherein the siloxane polymer comprises diphenylsiloxane-dimethylsiloxane copolymer, phenylmethylsiloxane-dimethylsiloxane copolymer, polyoctylmethylsiloxane, ethylmethylsiloxane-2-phenylpropylmethylsiloxane copolymer, poly(3,3,3-trifluoropropylmethylsiloxane), or dimethylsiloxane-ethylene oxide block copolymer.

15. The roofing membrane of claim 1, wherein the cured polymer layer comprises 0.5-20 wt. % of the silicone glycol copolymer.

16. The roofing membrane of claim 1, wherein the silyl-terminated polymer comprises a viscosity of 30000 to 62000 cP at 25° C.

17. The roofing membrane of claim 1, wherein the silyl-terminated polymer comprises a silyl-terminated polyether.

18. The roofing membrane of claim 1, wherein the inorganic filler comprises calcium carbonate particles having a median particle size of 1 micrometer to 25 micrometers.

19. The roofing membrane of claim 1, wherein the inorganic filler comprises calcium carbonate particles having a median particle size of 0.05 micrometer to 1 micrometer.

20. The roofing membrane of claim 1, wherein the cured polymer layer further comprises a catalyst.

21. The roofing membrane of claim 20, wherein the cured polymer layer comprises 0.01-3 wt. % of the catalyst.

22. The roofing membrane of claim 20, wherein the catalyst comprises an organo-tin compound.

23. The roofing membrane of claim 20, wherein the catalyst comprises a monobutyl tin compound, a dibutyl tin compound, or a dioctyl tin compound.

24. The roofing membrane of claim 1, wherein the cured polymer layer further comprises 0.01-45 wt. % plasticizer.

25. The roofing membrane of claim 1, wherein the cured polymer layer further comprises 1-5 wt. % pigment.

26. The roofing membrane of claim 25, wherein the pigment comprises particles having a median particle size of 0.1 micrometer to 2 micrometers.

27. The roofing membrane of claim 25, wherein the pigment comprises titanium dioxide.

28. The roofing membrane of claim 1, wherein the cured polymer layer further comprises 0.1-3 wt. % adhesion promoter.

29. The roofing membrane of claim 28, wherein the adhesion promoter comprises a bifunctional organosilane compound.

30. The roofing membrane of claim 28, wherein the adhesion promoter comprises N-(2-aminoethyl)-3-aminopropyltrimethoxysilane.

31. The roofing membrane of claim 1, wherein the cured polymer layer further comprises 0.01 to 3 wt. % moisture scavenger.

32. The roofing membrane of claim 31, wherein the moisture scavenger comprises an ethyl polysilicate, 1,1,1,3,3,3-hexamethyldisilazane, or an organofunctional silane.

33. A cured polymer layer comprising:
0.01-40 wt. % hydrophobic additive,
wherein the hydrophobic additive comprises one or more compounds selected from the group consisting of a hydrophobic polyether, a hydrophobic silane, a fatty acid ester, an organic titanate compound, a siloxane polymer, and a silicone glycol copolymer;
15-60 wt. % silyl-terminated polymer; and
15-60 wt. % inorganic filler,
wherein water absorption of the cured polymer layer is less than 25% by weight after an exposure period of 7 days when tested according to ASTM D471.

34. The cured polymer layer of claim 33, further comprising 0.01-45 wt. % plasticizer.

35. The cured polymer layer of claim 33, further comprising 0.01 to 3 wt. % moisture scavenger.
